(19) United States
(12) Patent Application Publication
(10) Pub. No.: US 2013/0286280 A1
(43) Pub. Date: Oct. 31, 2013

(54) Wireless Camera System

(71) Applicants: Jon Siann, Rancho Santa Fe, CA (US); Christopher Williams, San Diego, CA (US); Mark Sapper, Ramona, CA (US); Jorge Acosta, San Diego, CA (US); Joe Dang, San Marcos, CA (US); Chau Dang, San Diego, CA (US); Jason Cosky, San Diego, CA (US); Matthew Sadauckas, San Diego, CA (US)

(72) Inventors: Jon Siann, Rancho Santa Fe, CA (US); Christopher Williams, San Diego, CA (US); Mark Sapper, Ramona, CA (US); Jorge Acosta, San Diego, CA (US); Joe Dang, San Marcos, CA (US); Chau Dang, San Diego, CA (US); Jason Cosky, San Diego, CA (US); Matthew Sadauckas, San Diego, CA (US)

(73) Assignee: MICROPOWER TECHNOLOGIES, INC., San Diego, CA (US)

(21) Appl. No.: 13/457,392

(22) Filed: Apr. 26, 2012

(51) Int. Cl. H04N 5/225

(52) U.S. Cl. 348/372; 348/E05.024

(57) ABSTRACT

A wireless camera system is described. A housing enclosure contains the wireless camera, and the wireless camera collects video data. The housing enclosure also contains a first circuit board and a rechargeable battery. A first solar cell assembly is coupled to the housing enclosure. The first circuit board is in wireless communication with a base station, and the base station is configured to receive the video data. The camera operates a continuous feed of the video data. The video data is at least partially processed in a location away from the housing enclosure and made available to a remote client for viewing.

### BACKGROUND

Network camera systems can be based on Internet protocol (IP) and use Ethernet based networking technology. In some applications, network camera systems are replacing analog closed circuit television (CCTV) due to various factors, such as accessibility, ease-of-use, cabling scalability, and lower cost of deployment and operation. With the ubiquity of wireless networks such as WiFi networks (based on IEEE 802.11 standards) and the WiMAX networks (based on IEEE 802.16 standards), wireless network camera systems are gaining popularity and becoming a common platform for video surveillance applications.

In an IP surveillance environment, a network camera system can include IP cameras connected via twisted pair cabling to a network switch. Alternatively, the network connection can be achieved using wireless local area networking (LAN) technology standard. In various applications, IP cameras can include a web-server capability and remote clients or observers connected to the camera via standard TCP/IP interface standards such as FTP or HTTP. IP based network camera systems can be designed using commercial off-the-shelf (COTS) components from a diverse number of suppliers.

Some wireless camera systems draw power from rechargeable batteries. In order to have a compact wireless camera design, the rechargeable battery is typically a separate component from the camera housing. In systems in which the battery is integrated in the camera housing, the battery may enable the camera to operate for up to five hours of continuous feed of video data. Also, in these same systems in which the battery is integrated in the camera housing, the battery may enable the camera to operate and only record video data when triggered by motion.

Solar technology is often used as a renewable energy source. Solar cells are assembled together to make solar modules which are used to capture light energy from, for example, the sun and to convert it directly to electricity for commercial and residential applications. Typically, multiple solar modules are assembled together forming a solar panel and are connected electrically in series. In this type of connection, the current through each of the solar modules is the same, and the voltage across the components is the sum of the voltages across each solar module therefore limiting the entire current flow to that of the weakest solar cell.

Some solar systems employ bypass diodes to improve performance. A bypass diode allows a solar module's current to pass through a solar cell when that cell is compromised such as when shaded, soiled or damaged. If a solar cell becomes compromised, it acts as a resistor not producing as much current as the neighboring solar cells and forcing that solar cell into a reverse mode of operation. In this mode, the solar cell may dissipate a high wattage which may be destructive to the solar cell or module. When bypass diodes are used across solar cells connected in series, these diodes protect the array from the destructive effects of cell mismatch such as is caused, for example, by partial shading. However, such a connection does not provide tolerance to the disproportionate loss of array output power arising from such mismatch. By using a bypass diode, the current can use this bypass path around the non-conducting solar cell.

A wireless camera system is disclosed in “Wireless Network Camera System,” U.S. Pat. No. 8,050,206, issued Nov. 1, 2011, referred to as “Siann patent,” which is commonly owned with the current patent application and is hereby incorporated by reference in its entirety for all purposes.

### SUMMARY

A wireless camera system is described. A housing enclosure contains the wireless camera, and the wireless camera collects video data. The housing enclosure also contains a first circuit board and a rechargeable battery. A first solar cell assembly is coupled to the housing enclosure. The first circuit board is in wireless communication with a base station, and the base station is configured to receive the video data. The camera operates a continuous feed of the video data. The video data is at least partially processed in a location away from the housing enclosure and made available to a remote client for viewing.

The present invention is better understood upon consideration of the detailed description below in conjunction with the accompanying drawings and claims.

### DESCRIPTION OF DRAWINGS

FIG. 1 illustrates an example environment for a wireless camera communication system.

FIG. 2 details an embodiment of a wireless camera assembly.

FIG. 3 is a solar cell assembly mounted separately from a wireless camera assembly.

FIG. 4 details the top view of an embodiment of the wireless camera with the top cover of the housing removed.

FIG. 5 is a perspective view of an embodiment of the housing enclosure.

FIG. 6 shows a top view of an embodiment of a circuit board in position inside the housing enclosure.

FIG. 7 details a possible battery cover used inside of the housing enclosure.

FIG. 8 illustrates an air gap between the top of the housing enclosure and the solar cell assembly.

FIG. 9 depicts a top view of an exterior fan mounted to the top of the housing enclosure.

FIG. 10 shows a side view of an exterior fan mounted to the top of the housing enclosure.

FIG. 11 shows a top view of an embodiment of the solar cell assembly.

FIG. 12 illustrates a side view of an embodiment of the solar cell assembly.

FIG. 13 illustrates another side view of another embodiment of the solar cell assembly.

FIG. 14 is a bottom view of an embodiment of the solar cell assembly.

FIG. 15 is a side view of an embodiment of the solar cell assembly.

FIG. 16 is a bottom view of an embodiment of the solar cell assembly.

FIG. 17 is a side view of an embodiment of the solar cell assembly.

FIG. 18 details another embodiment of a wireless camera assembly.

### DETAILED DESCRIPTION

A wireless camera system is described. A housing enclosure contains the wireless camera, and the wireless camera collects video data. The housing enclosure also contains a first circuit board and a rechargeable battery. A first solar cell assembly is coupled to the housing enclosure. A base station, located separate from the housing enclosure, is in wireless communication with the first circuit board and is configured to receive the video data. The camera operates a continuous feed of the video data wherein the continuous video feed is at least 24 hours a day, and may be, for example, five days, seven days or for two weeks.

The video data is at least partially processed in a location away from the housing enclosure. A web server communication system transmits the video data and makes it available to a remote client for viewing.

The wireless camera assembly consists of a first solar cell assembly which may be mounted separately from the housing enclosure. The housing enclosure may be smaller than 38 cm by 23 cm by 23 cm, and in one embodiment, the housing enclosure is spherical with a diameter of less than 40 cm, for example 30 cm, 20 cm, or 15 cm. Also, the wireless camera assembly contains a first circuit board which monitors the rechargeable battery and controls an amount of power provided to the rechargeable battery to avoid overcharge and complete discharge conditions.

To aid in cooling the housing enclosure of the wireless camera assembly, an air gap is formed between the housing enclosure and the first solar cell assembly. This air gap may be greater than one cm and less than six cm. Optionally, a solar powered fan mounted on the housing enclosure may be used for additional cooling.

The solar cell assembly also comprises a first solar cell, a second solar cell and an interconnect. The interconnect is coupled to the first solar cell and the second solar cell. A diode coupled to the interconnect enables electricity follow in one direction from the first solar cell and through the diode and interconnect. Finally, the first solar cell assembly further comprises a second circuit board where the diode is coupled to the second circuit board.

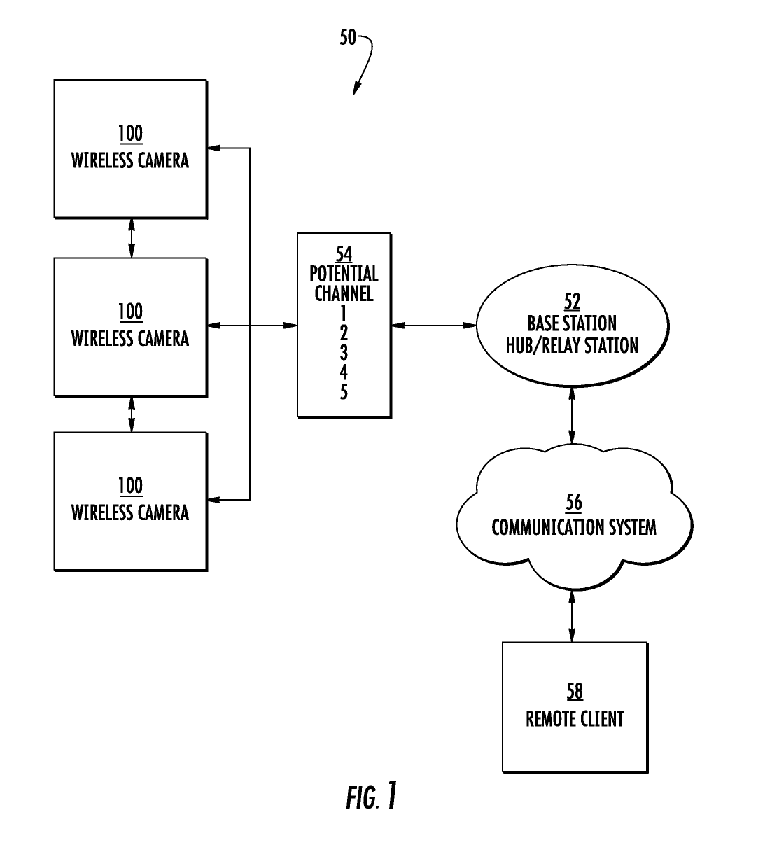

FIG. 1 illustrates an example environment for a wireless camera communication system 50. In this example, a network camera system includes a plurality of wireless camera assemblies 100. A plurality of wireless camera assemblies 100 may optionally communicate with one another. Wireless camera assemblies 100 transmit data to a base station 52 via a channel within potential channels 54, these channels are identified as channel 1, channel 2, channel 3, channel 4 and channel 5. Base station 52 may be located away from the wireless camera assemblies. Also, base station 52 may optionally contain a hub and may be optionally part of a relay device. A relay device may include a relay station, relay system, relay server or a simple relay. A plurality of wireless camera assemblies may also be associated with two or more hubs, base stations, or relay devices to provide redundancy in case one of the hubs, base stations, or relay devices experiences a failure. Furthermore, a plurality of wireless cameras assemblies may be associated with a plurality of hubs, base stations, or relay devices in a mesh-architecture to maximize redundancy, robustness, integrity, resiliency and efficient power operation.

Base station 52 is configured to receive information, such as video data, from the one or more wireless camera assemblies 100 and scans one or more potential communication channels 54 for channel availability between base station 52 and wireless camera assembly 100. Once an available channel 54 is obtained for data transmission based on the scanning of channel availability, the available channel in potential channels 54 is associated with a specific wireless camera assembly 100. The associating of the available channel within the potential channels 54 may include reserving the available channel for a predetermined period of time, and assigning the reserved available channel to the specific wireless camera assembly. In addition, during the predetermined period of time, the available channel may appear to other wireless camera assemblies 100 as unavailable for wireless communication in one embodiment, or may appear as available for wireless communication in another embodiment.

A communication system 56 connects base station 52 with the remote client 58 and transmits the video data to the client. This communication system 56 may be a network such as a wireless network (e.g., a Bluetooth connection, a cellular network, a wireless Ethernet network, a web server, a WiFi network, or a WiMAX network), or a wired network (e.g., LAN/WAN network, or POE network), a microwave link or any other type of available connection. Remote client 58 may be a device such as a video recording device (NVR), video management system, mobile phone, personal digital assistance (PDA), smartphone, laptop, computer or the like.

Wireless camera assembly 100 collects video data by recording and capturing images then processes this information by compressing the data in the camera. Other process may take place in the camera as well. Also, in one embodiment, base station 52, located away from the wireless camera assembly, at least partially processes the received video data from wireless camera assembly 100 and makes the data available to a remote client. The processing of the received video data may include conforming to a communication protocol between base station 52 and remote client 58 as well as enhanced processing of the data.

For the enhanced processing of the video data, complex and comprehensive algorithms or video analytics may be performed. This is done away from the wireless camera because the base station, remote server or other hub has more power and more computational resources than the wireless camera. In this manner, detection of additional triggering events beyond simple motion and other categories such as object recognition can be achieved as well as controlling contrast and brightness. These more comprehensive and complex algorithms may have the potential benefit of (i) increasing the accuracy and reliability of triggering event detection, (ii) and reducing probability of false detections or missing activity, objects or events. In this way, the link between base station 52 and remote client 58 is more pristine and robust.

The transmission of video data may be hidden and transparent to the remote client through the virtual web server or relay server in the base station. The web server or relay server may be located away from the base station as well. In addition, image and video analytical functions such as object recognition, people counting, and license recognition can be implemented in the base station (or web server or other hub) rather than in the wireless camera. These analytical functions can be implemented in a hidden way so that it logically appears to the remote client that these functions are occurring in the camera. In another embodiment, base station 52 may also be one or more devices such as computers receiving and at least partially processing the video data. Hence, the computers may function as base station 52 as well as remote client 58.

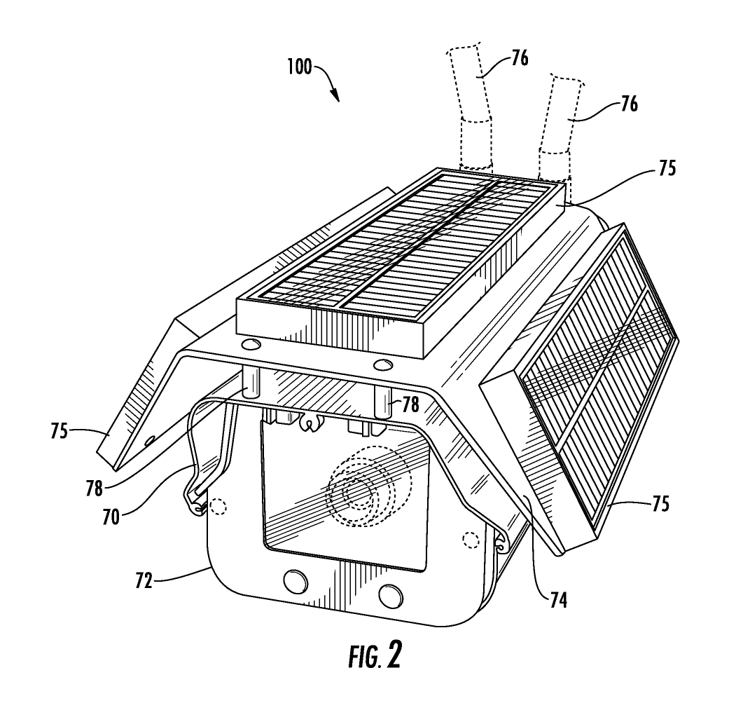

FIG. 2 details an embodiment of wireless camera assembly 100. Wireless camera assembly 100 is comprised of a housing enclosure which has a top of housing enclosure 70 and a bottom of housing enclosure 72, a solar cell assembly 74 and one or more antennas 76. Since the average power consumption of wireless camera assembly 100 is relatively small, solar cell assembly 74 may be used as a power source for the camera. Solar cell assembly 74 is coupled to top of housing enclosure 70 by fasteners 78 at four locations on top of housing enclosure 70, two on the front end and two on the rear end, and converts light energy from a source to electricity thus recharging an internal battery (discussed below). Solar cell assembly 74 may be coupled to top of housing enclosure 70 for other means as well. In other embodiments, the internal battery may be recharged by one or more solar cells, fuel cells, galvanic cells, flow cells, kinetic power generators and/or environmental energy sources. The overall dimension for wireless camera 100 is approximately 41 cm by 16 cm by 26 cm.

Top of housing enclosure 70 and bottom of housing enclosure 72 may be made of metal, plastic, composite material or the like. In one embodiment, when top of housing enclosure 70 and bottom of housing enclosure 72 are coupled together, the housing enclosure is smaller than approximately 41 cm by 16 cm by 13 cm.

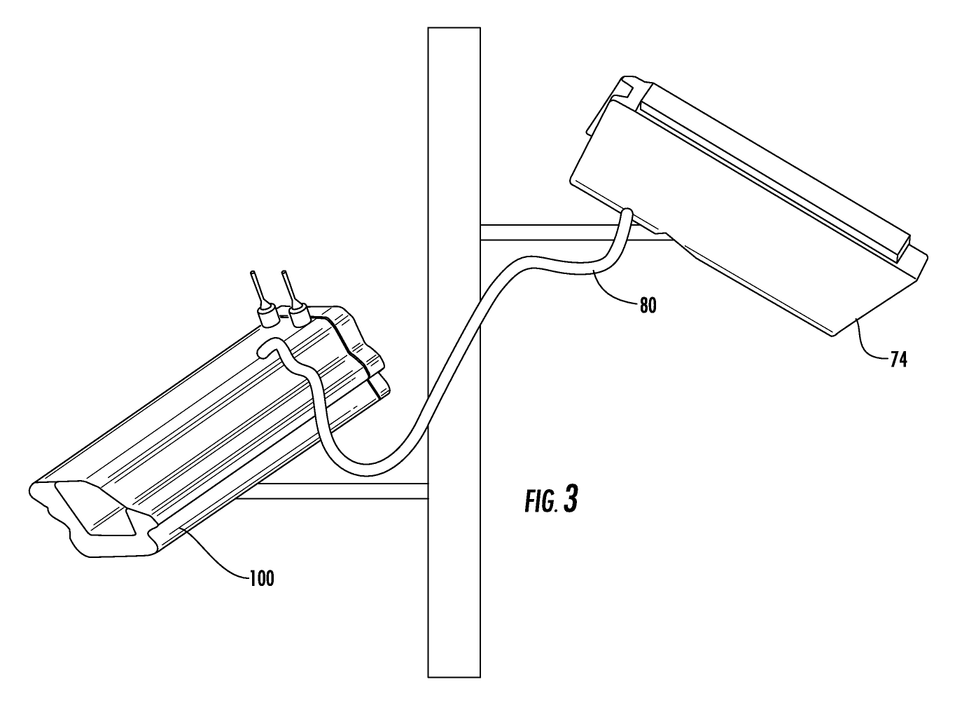

In some applications, solar cell assembly 74 is detachable and may be mounted separately from wireless camera assembly 100 as shown in FIG. 3. Referring to FIG. 3, solar cell assembly 74 is mounted away from wireless camera assembly 100. A wire 80 connects the two components for communication. For example, wireless camera assembly 100 may not be mounted in an area with a sufficient amount of sunlight to generate the necessary power required. Mounting solar cell assembly 74 away from wireless camera assembly 100 allows solar cell assembly 74 to be positioned for an optimal amount of sunlight. In another example, solar cell assembly 74 may be mounted away from wireless camera assembly 100 therefore allowing wireless camera assembly 100 to be mounted discreetly and hidden from view. This may be advantageous in surveillance applications.

Because solar cell assemblies are used to generate power, in further embodiments, multiple solar cell assemblies may be used with wireless camera assembly 100 depending on power demands. These multiple solar cell assemblies may be attached directly to wireless camera assembly 100 or mounted away from wireless camera assembly 100 using a wire between the components for communication. For example, if wireless camera assembly 100 consumes 12 Watts per hour per day, solar cell assembly 74 needs to meet that demand. If this is not possible given the particular solar cell assembly, then additional solar cell assemblies may be wired to wireless camera assembly 100 to generate the necessary power.

In one embodiment, solar cell assembly 74 is comprised of three solar cell modules 75 (see FIG. 2). Each solar cell module 75 has the dimensions of approximately 30.5 cm by 10 cm by 1.25 cm. Each solar cell module 75 may be comprised of 24 individual solar cells 140.

In yet further embodiments, other solar cell, solar cell module and/or solar cell assembly configurations such as various sizes and shapes may be used with wireless camera assembly 100 depending on the optimal design for power demands and mounting space. For example, more or less solar cells than disclosed may be combined to form a solar cell module as well as more or less solar modules to form solar cell assemblies. These solar cells, solar cell modules and solar cell assemblies may use or form additional shapes such as square, triangle, diamond, octagon or the like. The flexibility of these designs are advantageous. For example, if the mounting area for the solar cell assembly is confined by size, solar modules may be combined in such a manner to fit the constraint.

FIG. 4 details one embodiment of bottom of housing enclosure 72 of wireless camera assembly 100. Bottom of housing enclosure 72 is shown with an example camera 106 mounted on it. Camera 106 collects video data by recording and capturing images. An internal battery 104 is also coupled to bottom of housing enclosure 72 by two L-brackets 108. In one embodiment, internal battery 104 is a rechargeable, lead-acid battery which is commercially available, for example, from the manufacturer Power-Sonic and measures approximately 15.2 cm by 9.5 cm by 5 cm. These types of batteries typically have a very low energy-to-weight ratio and a low energy-to-volume ratio but have the ability to supply high surge currents meaning that the cells maintain a relatively large power-to-weight ratio. In a further embodiment, internal battery 104 may be customized for such factors such as power density, durability, temperature performance, safety and cost.

Wireless camera assembly 100 has low power consumption thus allowing internal battery 104 to be relatively small in physical size and integrated into the housing enclosure. In fact, internal battery 104 allows camera 106 to operate a continuous feed of the video data for at least 24 hours a day, for five days, or seven days or for two weeks under normal circumstances (i.e., unless the system shuts down for repair or relocating or the like).

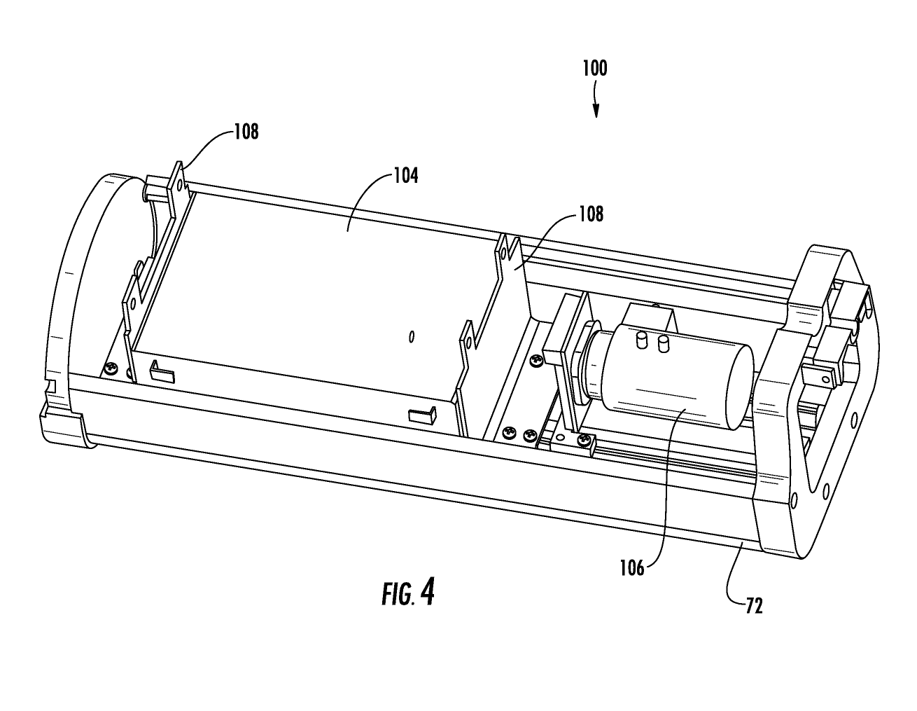

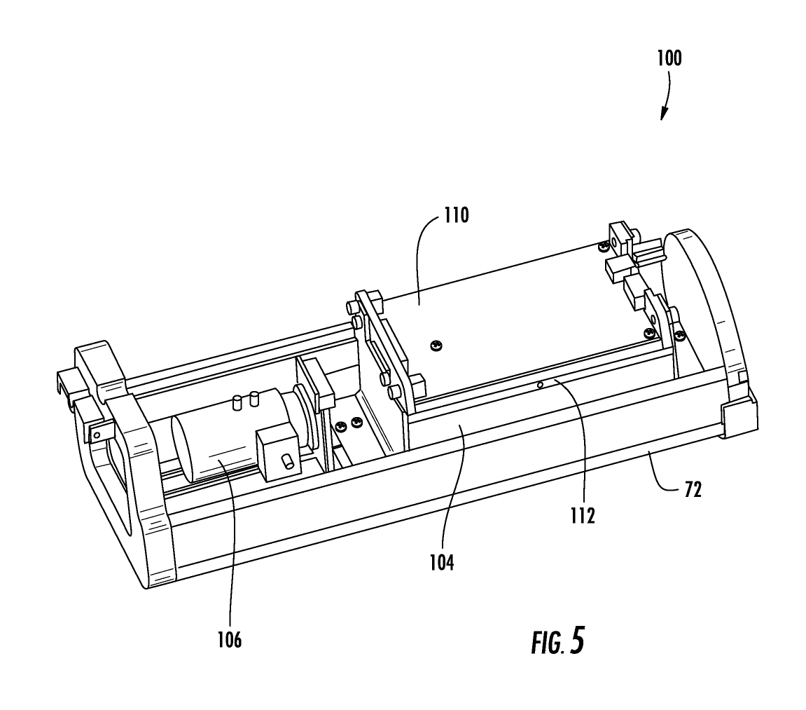

A wireless camera first circuit board 110 is also contained in the housing enclosure and shown in a perspective view in FIG. 5. To secure internal battery 104, a top plate 112 is mounted on top of internal battery 104 then circuit board 110 is coupled to top plate 112. FIG. 6 shows a top view of circuit board 110 in position. In this embodiment, there are four electrical connections to circuit board 110. Wires 114 are used to communicate between circuit board 110 and antennas 76 (refer to FIG. 2), wire 116 connects circuit board 110 to solar cell assembly 74 (refer to FIG. 2), and wire 118 links circuit board 110 to internal battery 104.

Circuit board 110 may monitor the voltage of internal battery 104 and may control the amount of power provided to internal battery 104 to avoid overcharge and complete discharge conditions which may damage or reduce the efficiency of internal battery 104. For example, if there is not enough sunlight to charge internal battery 104, circuit board 110 will shut down the system.

In this embodiment, circuit board 110 manages the power for wireless camera assembly 100 by using maximum power point tracking (MPPT). MPPT is a technique to maximize the possible power from one or more solar cell assemblies by sampling the output of the solar cells and applying the proper resistance or load to obtain the maximum power for a given environmental condition. A base station, located separate from the housing enclosure, is in wireless communication with circuit board 110.

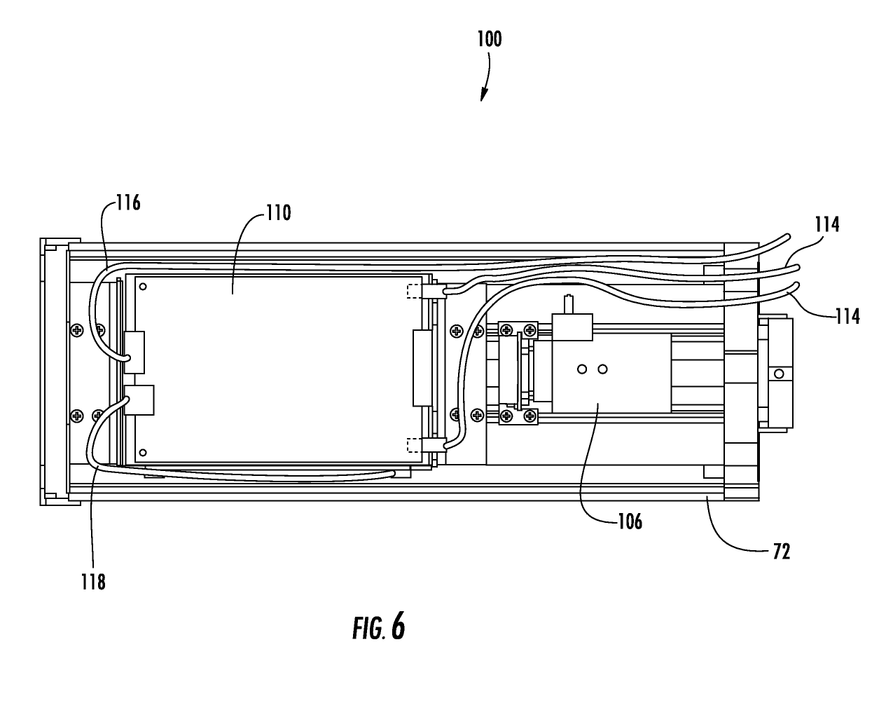

FIG. 7 details a cover 120 which may be used inside of the housing enclosure. Cover 120 couples to internal battery 104 and secures and protects internal battery 104, circuit board 110 and the various wires detailed in FIG. 6.

In one embodiment, during use of wireless camera assembly 100, the temperature of top of housing enclosure 70 and bottom of housing enclosure 72 may be at ambient temperature. The shape of solar cell assembly 74 may help to reduce the temperature of the housing enclosure by providing shade for top of housing enclosure 70, thus shielding it from direct sunlight and assisting in cooling top of housing enclosure 70.

In FIG. 8, an air gap 122 is formed between top of housing enclosure 70 and solar cell assembly 74 for cooling and air circulation. Air gap 122 may be greater than one cm and less than six cm. Air flowing between solar cell assembly 74 and top of housing enclosure 70 may further cool housing enclosure 72.

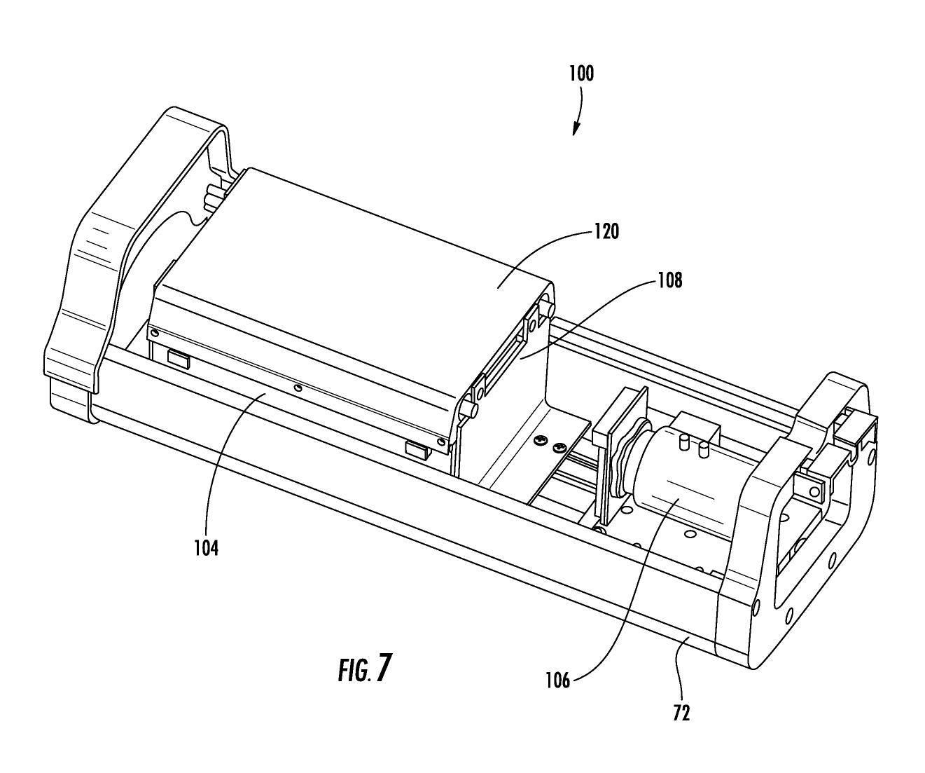

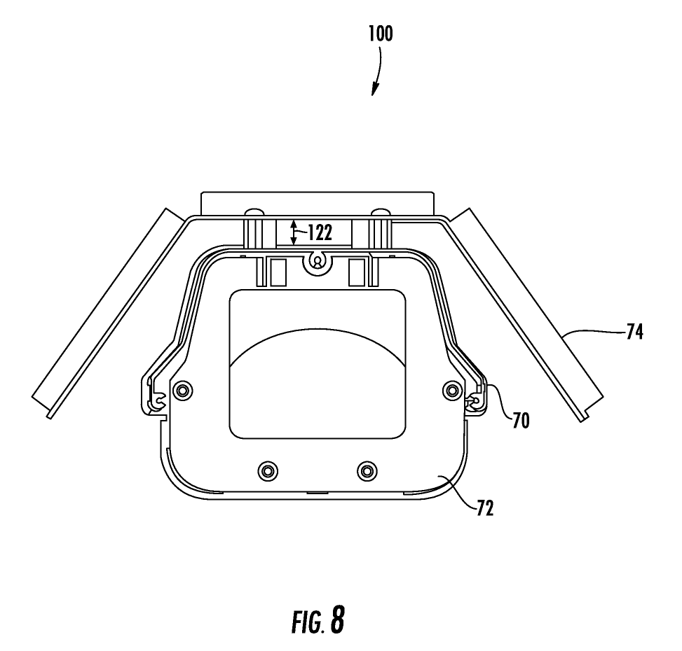

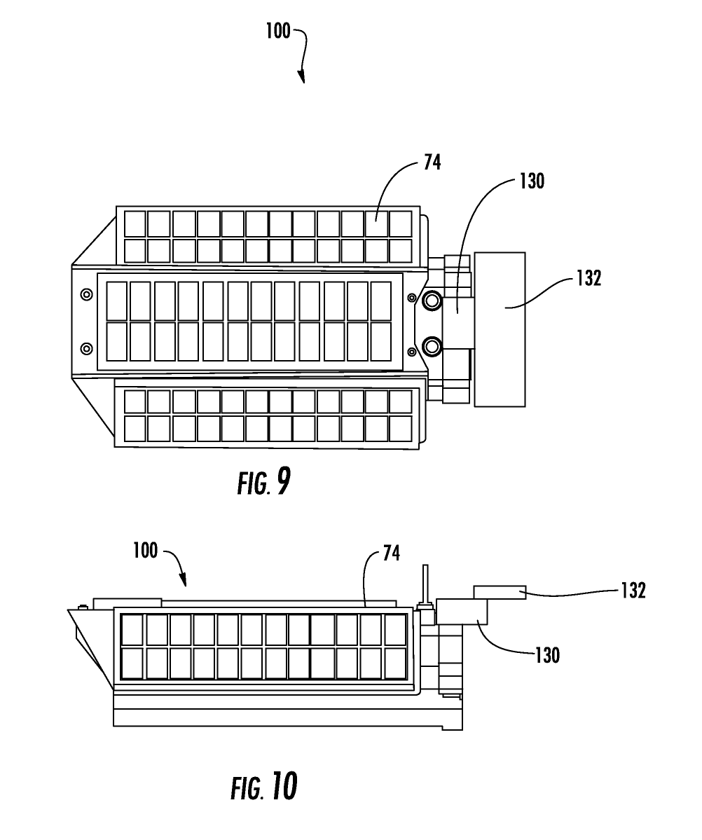

Optionally, an exterior fan 130 may be used for further cooling and air circulation, as shown in FIGS. 9 and 10. In this embodiment, fan 130 is mounted to top of housing enclosure 70 at the rear end and positioned to pass and circulate air in air gap 122. Air gap 122 carries the air along top of housing enclosure 70 to provide the desired cooling effect. Wireless camera assembly 100 is typically mounted for use with the front end pointing downward. By mounting fan 130 at the rear end of top of housing enclosure 70, heat transfer is encouraged because heat rises. In one embodiment, fan 130 has a fan solar cell assembly 132 independent from solar cell assembly 74 for operation. In another embodiment, fan 130 is powered by the solar assembly 74 used to recharge internal battery 104 (see FIG. 4). Fan 130 may use sleeve bearings, rifle bearings, ball bearings, fluid bearings, magnetic bearings (e.g., maglev), or the like.

One function of a solar cell assembly is to convert light energy from the sun to power in the form of electricity. If the solar cell assembly becomes compromised, for example, fully or partially shaded, soiled or damaged, the solar cell assembly acts as a resistor having a disproportionate loss in output or local overheating and destruction. If other non-compromised solar cell assemblies are connected in series with the compromised solar cell assembly, the non-compromised solar cell assemblies will attempt to force current through the now resistive solar cell assembly. This current flow may result in excessive heat build-up and may cause damage to the solar cell assembly.

A goal in solar cell technology is extracting the maximum amount of energy from an available solar cell assembly which may be comprised of one or more solar cells. If individual solar cells or groups of solar cells are compromised and these are connected in series, then less energy may be extracted. Employing bypass diodes, which are surface mounted components attached to the solar cells, allows a one-way path for the current to pass through, thus enabling power to be extracted. Individual solar cells or groups of solar cells may then be bypassed rather than bypassing the entire solar cell assembly.

For example, if 24 solar cells form a solar cell assembly and each solar cell generates 0.5 volts (v), the total output for the solar cell assembly is 12.0 v (24×0.5 v). If one solar cell becomes shaded such as by a tree, building, pole or the like, it generates 0.0 v. Because the solar cells are connected in series, the total power extracted from the solar cell assembly will be 0 v. However, if a diode is used, the diode provides a path for the current around the shaded solar cell and prevents backflow, thus reducing the amount of local heating at the shaded cell. Therefore, if only one cell is shaded, the total power extracted is then 11.5 v (23×0.5 v).

FIG. 11 shows a top view of solar cell assembly 74. Here, solar cell assembly 74 may be comprised of a first solar cell and a second solar cell, or more solar cells 140. An interconnect 142 is coupled between solar cells 140 and daisy-chained together. Interconnect 142 is a thin strip of metal which allows electricity to flow through. A diode 144 is coupled to interconnect 142 allowing electricity to follow in one direction from a first solar cell 140 through diode 144 and interconnect 142. This coupling may be achieved by soldering or other available techniques.

A plurality of interconnects and diodes may be used to link multiple solar cells together. Diodes 144 may be mounted on the top surface of solar cell assembly 74 as shown in FIG. 11.

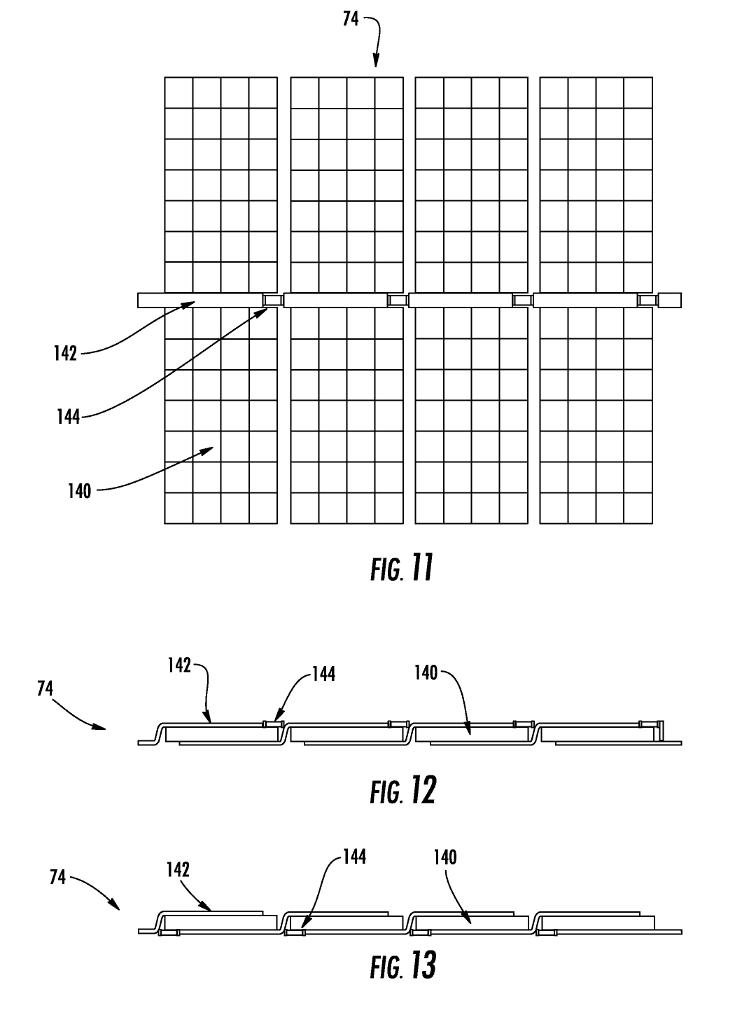

FIG. 12 illustrates a side view of this embodiment. In another embodiment, diodes 144 may be mounted on the underside of solar cell assembly 74 as shown in FIG. 13. FIG. 13 is a side view of diodes 144 mounted on the underside of solar cell assembly 74. Mounting diodes to the underside of the solar cell assembly may be advantageous for discreetness, protection from weather and restriction because no shade is cast on the solar cell from the diode as may be the case with a top mounted configuration. In a further embodiment, diodes 144 may be mounted to the outer edge of solar cell 140.

Diodes 144 may also be coupled to a circuit board or a double-side circuit board. In a double-side circuit board, the films used are two layers of the same circuit and not separate boards, and the two sides interact with each other passing signals and voltage from one side to the other. The use of integrating diodes with a circuit board may increase reliability, increase durability and simplify installation.

Attaching the bypass diodes can be achieved by soldering them directly to the solar cells, or by using printed circuit board technology, or other available techniques. In one embodiment, the individual diodes may be soldered directly to the solar cell array before being encapsulated in a typical solar cell panel. In another embodiment, the soldering is automated, for example, the solar cells form one array while a circuit board with integrated diodes form a second array then the two arrays are attached.

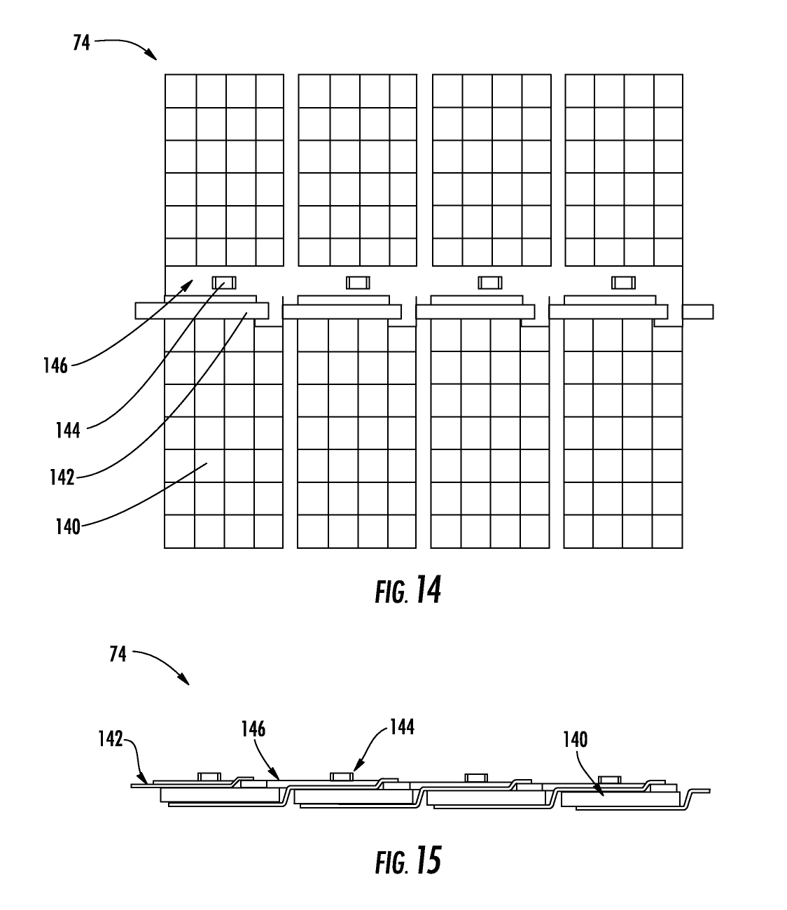

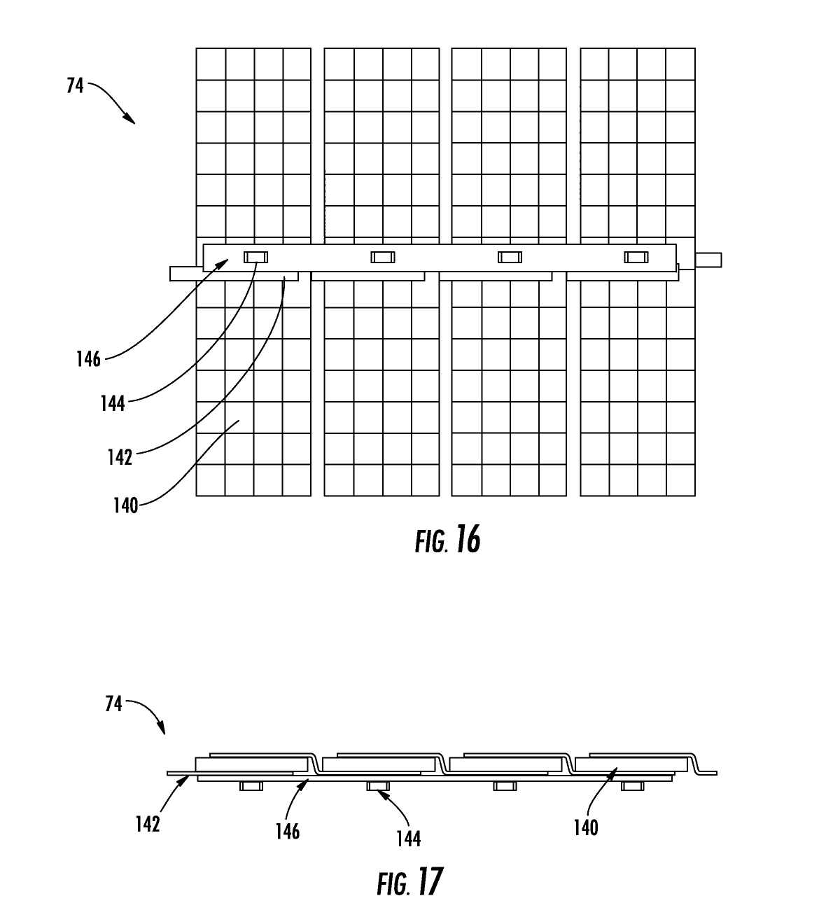

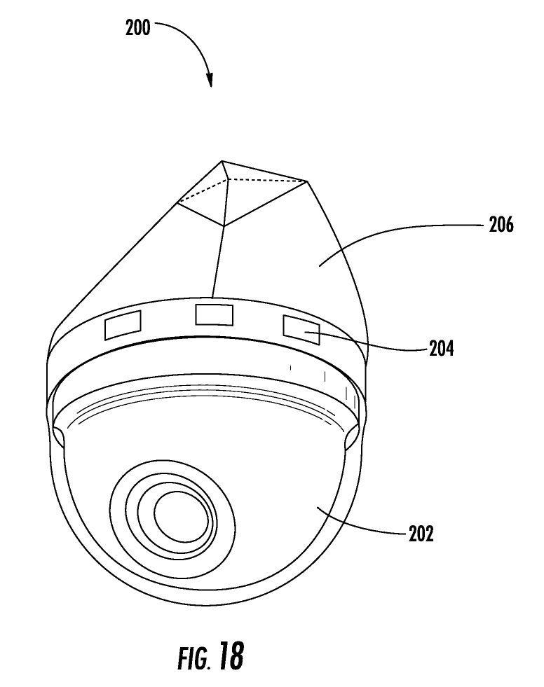

A circuit board 146 with the integrated diodes 144 may be mounted under interconnects 142 as shown in the bottom and side view of FIGS. 14 and 15 respectively. This circuit board 146 with the integrated diodes 144 may also be mounted over interconnects 142 as shown in the bottom and side view of FIGS. 16 and 17 respectively.

The number of diodes used and the placement of diodes may be customized depending on the application. One bypass diode per solar cell may be used or bypass diodes may be placed across groups of solar cells. As discussed above, the diodes may be mounted on the topside or underside of the solar cells or on the side of the array. The pattern of the diode placement may also be customized creating a regular or irregular pattern.

Referring to FIG. 4, internal battery 104 is contained in the housing enclosure; therefore, the physical size of internal battery 104 dictates the minimum size of the housing enclosure. For example, as the internal battery is designed smaller, the housing enclosure may become smaller. In one embodiment, the housing may be smaller than 37 cm by 14.5 cm by 12 cm. In another embodiment the housing enclosure may be smaller than 33 cm by 13 cm by 10.5 cm. FIG. 18 details yet another embodiment of wireless camera assembly 200. A housing enclosure 202 is spherical or dome-shaped with a diameter of less than 40 cm.

Housing enclosure 202 contains a small internal, rechargeable battery, approximately 16 cm by 5 cm by 5 cm, a circuit board and a camera. The internal, rechargeable battery may be, for example, a lead-acid battery or a lithium battery. A solar cell assembly 206 is used as a renewable energy source and is comprised of diamond shaped solar cells. Solar cell assembly 206 is shown as being mounted to housing enclosure 202. It may also be electrically coupled to housing enclosure 202 and mounted separately from it.

Multiple antennas 204 for communication may utilize beam steering technology. The size of wireless camera assembly 200 is approximately 16 cm by 16 cm by 31 cm wherein the housing enclosure is spherical with a diameter of less than 40 cm, for example about 30 cm, about 20 cm, about 15 cm, about 11 cm, about 10 cm, about 9 cm, about 8 cm, about 7 cm and about 6 cm.

While the specification has been described in detail with respect to specific embodiments of the invention, it will be appreciated that those skilled in the art, upon attaining an understanding of the foregoing, may readily conceive of alterations to, variations of, and equivalents to these embodiments. These and other modifications and variations to the present invention may be practiced by those of ordinary skill in the art, without departing from the spirit and scope of the present invention. Furthermore, those of ordinary skill in the art will appreciate that the foregoing description is by way of example only, and is not intended to limit the invention. Thus, it is intended that the present subject matter covers such modifications and variations.

What is claimed is:

1. A camera system comprising:
a housing enclosure;
a camera for collecting video data;
a first circuit board in wireless communication with a base station, the base station being configured to receive the video data;
a rechargeable battery; and
a first solar cell assembly coupled to the housing enclosure; and
wherein the camera operates a continuous feed of the video data; and
wherein the video data is at least partially processed in a location away from the housing enclosure and made available to a remote client for viewing.

2. The wireless camera system of claim 1, wherein the video data is at least partially processed in the base station.

3. The wireless camera system of claim 1, wherein a web server in a location away from the housing enclosure transmits the video data to a client.

4. The first solar cell assembly of claim 1, wherein the first solar cell assembly is mounted separately from the housing enclosure.

5. The first solar cell assembly of claim 1, wherein an air gap is formed between the housing enclosure and the first solar cell assembly.

6. The first solar cell assembly of claim 5, wherein the air gap is greater than one cm and less than six cm.

7. The first solar cell assembly of claim 1, further comprising:
a solar powered fan mounted on the housing enclosure.

8. The system of claim 1, wherein the first circuit board monitors the rechargeable battery and controls an amount of power provided to the rechargeable battery to avoid overcharge and complete discharge conditions.

9. The system of claim 1, wherein the housing enclosure is smaller than 41 cm by 16 cm by 13 cm.

10. The system of claim 1, wherein the housing enclosure is smaller than 37 cm by 14.5 cm by 12 cm.

11. The system of claim 1, wherein the housing enclosure is smaller than 33 cm by 13 cm by 10.5 cm.

12. The system of claim 1, wherein the continuous video feed is 24 hours a day for at least five days.

13. The system of claim 1, wherein the first solar cell assembly comprises:
a first solar cell;
a second solar cell;
an interconnect coupled to the first solar cell and the second solar cell; and
a diode coupled to the interconnect wherein electricity follows in one direction from the first solar cell and through the diode and interconnect.

14. The system of claim 13, wherein the first solar cell assembly further comprises a second circuit board wherein the diode is coupled to the second circuit board.

15. The wireless camera system of claim 1, wherein the housing enclosure is spherical with a diameter of less than 40 cm.

16. A method for providing a camera system, the method comprising the steps of:
enclosing a camera, a circuit board, a rechargeable battery and a radio in a housing; and
coupling a first solar cell assembly to the housing;
wherein the camera operates a continuous feed of video data;
wherein the radio communicates with a base station; and
wherein the video data is at least partially processed in a location away from the housing and made available to a remote client for viewing.

17. The method of claim 16, wherein the video data is at least partially processed in the base station.

18. The method of claim 16, wherein an air gap is formed between the housing and the first solar cell assembly.

19. The method of claim 16, wherein the housing is spherical with a diameter of less than 40 cm.

20. The system of claim 16, wherein the continuous video feed is 24 hours a day for at least five days.
